(19) United States
(12) Patent Application Publication
(10) Pub. No.: US 2009/0234702 A1
(43) Pub. Date: Sep. 17, 2009

(54) Method of process control for widely distributed manufacturing processes

(76) Inventor: James S. Chester, St. Petersburg, FL (US)

Correspondence Address: WILEY HORTON, 215 SOUTH MONROE STREET, 2ND FLOOR, TALLAHASSEE, FL, 32301, US

(21) Appl. No.: 12/381,437

(22) Filed: Mar. 12, 2009

Related U.S. Application Data
(60) Provisional application No. 61/069,042, filed on Mar. 12, 2008.

(51) Int. Cl. G06Q 10/00; G06F 17/30; G06F 17/40; G06Q 50/00; G06Q 30/00

(52) U.S. Cl. 705/9; 705/29; 707/104.1; 705/26; 707/E17.032; 707/E17.044

(57) ABSTRACT

An integrated process management system particularly suited for an environment in which multiple vendors must interact to cooperatively deliver products. The invention uses a preferably centralized process controller running on a computer. Discrete items or steps in the product manufacturing and delivery processes are given unique identifiers. The unique identifiers may assume many forms. For physical components, such as containers of raw materials, the identifier can be a tamper-resistant label containing a unique alphanumeric sequence. The identifiers are used to track the performance of each defined step in the process.

### CROSS-REFERENCES TO RELATED APPLICATIONS

This application is a non-provisional application claiming the benefit pursuant to 37 C.F.R. §1.53 (c) of an earlier-filed provisional application. The provisional application was filed on Mar. 12, 2008 and was assigned Ser. No. 61/069,042. It listed the same inventor.

### STATEMENT REGARDING FEDERALLY SPONSORED RESEARCH OR DEVELOPMENT

Not Applicable.

### MICROFICHE APPENDIX

Not Applicable

### BACKGROUND

1. Field of the Invention

This invention relates to the field of process management. More specifically, the invention comprises a method for ensuring process control where multiple vendors are involved.

2. Background of the Invention

A new product goes through a series of steps from its initial conception to the actual distribution of the product to a consumer. This process can be described in many ways for many different products. The reader may wish to know how a particular exemplary production process functions, in order to understand how the present inventive method applies to a particular production process. However, the reader should bear in mind the fact that there are an infinite variety of production processes and the present invention could be adapted to apply to most all of them. Thus, the examples given in this background section should be viewed as exemplary and are in no way intended to define the scope of the present invention.

FIG. 1 provides a typical example of a product life cycle. A product is initially conceived. Its product characteristics are then defined (such as the fact that it will be a toy doll intended to sell within a particular segment of the market at a particular price). Once the nature of the product is understood, vendors for the product must be sourced (assuming that manufacturing is to be performed by an external entity, which is now typically the case). The next steps are then: (1) Defining the product attributes (such as the fact that its major components will be made of molded plastic); (2) Provisioning (obtaining the materials needed to produce the product); (3) Defining the order attributes (essentially the information that a purchaser will need to provide in order to initiate the delivery cycle); and (4) Ultimately fulfilling an order that has been placed.

Those skilled in the art will know that each major step shown in a block in FIG. 1 is actually comprised of numerous smaller steps. Examples of the types of smaller steps typically encountered are depicted in FIGS. 2 through 7. FIG. 2 shows the components of the concept phase. This involves: (1) Identifying a target price and market; (2) Creating a top-level product design; (3) Creating a detailed product description; and (4) Finalizing the product's engineering. This last stage has traditionally meant creating a set of detailed engineering drawings. As the art migrates away from documents toward electronic data, this last step may also simply mean finalizing a Computer aided Design (“CAD”) model for the product.

FIG. 3 shows detailed steps typically used to define the product's characteristics. They include: (1) Defining a production and delivery schedule, including the identification of long-lead items that will “pace” the program; (2) Performing vendor cost evaluations; (3) Creating a bid package having all the information a prospective vendor needs to provide a quote; (4) Defining the anticipated costs; (5) Created actual production drawings or comparable electronic data; and (6) Creating a components definition. The block for “components definition” is surrounded by a dashed line, which is intended to indicate a present weakness in the systems in use. The present process contemplates defining each step performed by each vendor as a product has gone from the most basic concept all the way through to a delivered good. This level of detail has been previously lacking.

FIG. 4 shows some detailed steps typically found in the sourcing phase. These include: (1) Determining which vendors can handle which degree of complexity; (2) Ensuring source compliance with the product definition; (3) Determining vendor capacity; (4) Understanding each vendor's labor situation; and (5) Understanding each vendor's facility situation. The reader should note that the steps shown are not necessarily an exhaustive listing. The steps may not necessarily be performed in the order presented. In fact, in many instances a company will wish to perform some of the steps simultaneously.

The steps in FIG. 4 can be particularly important for instances where the vendor is located in a different country having different product and labor standards. The ability to monitor a vendor's compliance with the product definition initially laid down is very important. The block for “source compliance” is surrounded by a dashed line, indicating that present control methods do not adequately address this issue.

FIG. 5 illustrates steps in the provisioning process. These include: (1) Scheduling/logistics; (2) Determining component availability; (3) Obtaining customer information; (4) Determining sales channels and appropriate pricing; and (5) Performing laboratory testing (both internally and through the use of independent certifying labs). The laboratory testing step is surrounded by a dash to again indicate a present weakness. Throughout the remaining figures, the presence of a dashed box indicates a present weakness.

FIG. 6 illustrates the steps in defining what information will be needed for orders. These steps include: (1) Determining the appropriate product or packaging marking; (2) Developing a notification scheme; (3) Defining a purchase order; (4) Establishing how authority to proceed shall be given; (5) Performing line testing; (6) Controlling vendor revisions; and (7) Establishing customer accounts.

Finally, FIG. 7 illustrates typical steps in actually fulfilling a customer order. These include: (1) Providing “lot insight,” meaning the ability to obtain specific information about each lot produced; (2) Controlling collections; (3) Ensuring product integrity over time; (4) Providing for discounts; (5) Controlling the payment of royalties or licensing fees; (6) Providing for rebates; and (7) Providing post-sale product awareness (meaning the ability to track a product after it is sold to the initial customer.

Of all the steps identified as a weakness in present process control systems, the “lot insight” step is possibly the greatest. A problem with a particular product is often identified after the product has reached the store shelves. A good example of such a problem would be the discovery of lead paint on a child's toy. The manufacturer ideally needs to be able to trace the origin of the particular toy all the way back to its raw materials, in order to establish who is responsible for the problem and take corrective action. Unfortunately, present process controls do not provide this level of information.

Many of these steps have traditionally been performed by various divisions operating under the structure of a single corporation. This is increasingly no longer the case. Modern “manufacturers” have become design and marketing bureaus that outsource many of the roles traditionally performed internally. FIGS. 8-10 illustrate this concept.

FIG. 8 shows generally the stages involved in manufacturing a product and providing it to the consumer. The traditional corporate model obtained the raw materials externally but performed the rest of the steps within the company. In the current environment, a corporate “manufacturer” may actually elect to perform none of the steps shown in FIG. 8.

FIGS. 9 and 10 show a typical production process for a domestic company whose products are made overseas. Twelve vendors are involved in the process (which is a fairly simple example). Vendor 1 produces plastic molds and ships these to Vendor 3 (the molder). Vendor 3 obtains raw plastic pellets from Vendor 2. Vendor 3 then molds the plastic parts and sends them to Vendor 7 (the assembler). Vendor 7 also obtains paint from Vendor 6, textiles from Vendor 4, decorated packaging from Vendor 8, and raw hair fibers from Vendor 5 (the product being a toy doll). Once the assembler finishes the products and packages them for shipping, they are delivered to Vendor 9, the shipper.

The shipper takes the packaged products to a receiving port (Vendor 10, shown in FIG. 10), where they are unloaded. Vendor 11 then transports the products to Vendor 12—a distributor. The products are then shipped to various retailers where they are placed on the store shelves.

Those skilled in the art will know that the domestic company does not necessarily deal with all these vendors. It is common for the domestic company to contract only with the assembler (Vendor 7) and depend upon the assembler for controlling the other portions of the process prior to shipping. However, the domestic company is ultimately held responsible for issues with its products. This lack of individual vendor contact and regulation in fact represents a shortcoming of the current model. This shortcoming is among the problems the present invention seeks to correct.

### BRIEF SUMMARY OF THE INVENTION

The present invention comprises an integrated process management system particularly suited for an environment in which multiple vendors must interact to cooperatively deliver products. The invention uses a preferably centralized process controller running on a computer. Discrete items or steps in the product manufacturing and delivery processes are given unique identifiers. The unique identifiers may assume many forms. For physical components, such as containers of raw materials, the identifier can be a tamper-resistant label containing a unique alphanumeric sequence.

In the case of a non-physical step in the process, such as the completion of a quality inspection, the identifier can be a software agent to which a vendor must respond appropriately. The process controller preferably includes “knowledge” regarding the process it is controlling, such as anticipated completion dates for various steps. Using this knowledge, the process controller can identify problems and prompt appropriate corrective action. The process controller also preferably includes the capacity to learn from past activities, so that its “knowledge” of the process will improve over time.

REFERANCE NUMERALS USED

| | | | |
|---|---|---|---|
| 10 | identifier | 12 | bar code |
| 14 | alphanumeric sequence | 16 | hologram background |
| 18 | peel-altered region | 20 | adhesive substrate |
| 22 | hologram | 24 | RFID chip |
| 26 | graphical user interface | 28 | order field |
| 30 | description field | 32 | code field |
| 34 | authentication prompt | 36 | success indicator |
| 38 | message field | 40 | tracking prompt |
| 42 | reply message prompt | 44 | step description |
| 46 | action prompt | 48 | process control user interface |
| 50 | browse options | 52 | lot data |
| 54 | vendor data | 56 | supplier data |
| 58 | cross link | 60 | compliance history |
| 62 | report link | 64 | software agent |
| 66 | response input | | |

### DRAWING FIGURES

FIG. 1 is a schematic view, showing a product life cycle.

FIG. 2 is a schematic view, showing the detailed steps in a portion of the product life cycle of FIG. 1.

FIG. 3 is a schematic view, showing the detailed steps in a portion of the product life cycle of FIG. 1.

FIG. 4 is a schematic view, showing the detailed steps in a portion of the product life cycle of FIG. 1.

FIG. 5 is a schematic view, showing the detailed steps in a portion of the product life cycle of FIG. 1.

FIG. 6 is a schematic view, showing the detailed steps in a portion of the product life cycle of FIG. 1.

FIG. 7 is a schematic view, showing the detailed steps in a portion of the product life cycle of FIG. 1.

FIG. 8 is a schematic view, showing a typical manufacturing process.

FIG. 9 is a schematic view, showing some of the detailed steps involved in the manufacturing process of FIG. 8.

FIG. 10 is a schematic view, showing some of the detailed steps involved in the manufacturing process of FIG. 8.

FIG. 11 is a perspective view, showing some of the identifiers for use in the present inventive process.

FIG. 12 is a perspective view, showing how the identifiers can be affixed to physical components or steps in the process.

FIG. 13 is a schematic view, showing how the process control interacts with multiple vendors over the Internet.

FIG. 14A is a schematic view, showing how the process control interacts with various vendors over time.

FIG. 14B is a schematic view, showing how the process control interacts with various vendors over time.

FIG. 15 is a schematic view, showing how the process control interacts with various vendors over time.

FIG. 16 is a perspective view, showing identifiers affixed to different elements in the manufacturing cycle of a single product.

FIG. 17 is a schematic view, showing a representative graphical user interface that can be presented to a vendor.

FIG. 18 is a schematic view, showing a representative graphical user interface that can be presented to a vendor.

FIG. 19 is a schematic view, showing a representative graphical user interface that can be presented to a vendor.

FIG. 20 is a schematic view, showing a representative graphical interface for use in process control.

FIG. 21 is a schematic view, showing a representative graphical interface for use in process control.

FIG. 22 is a schematic view, showing a representative graphical interface for use in process control.

### DETAILED DESCRIPTION OF THE INVENTION

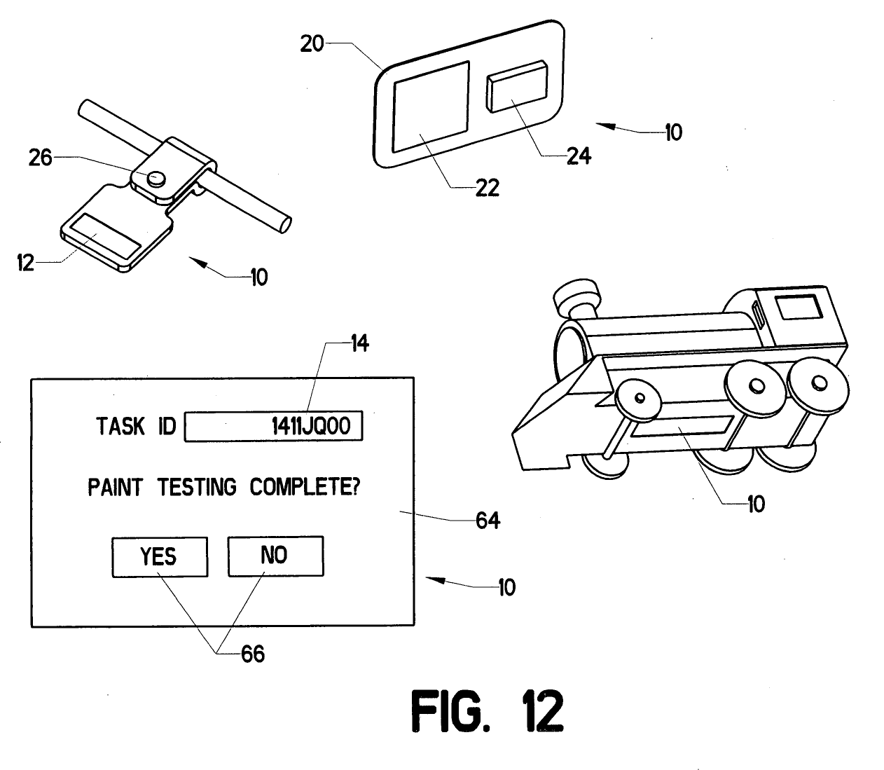

An essential component of the present invention is the provision of a unique identifier for most (and preferably all) of the steps and components in a product's life cycle. The identifier can assume many forms, and it need not be physical. It must, however, be able to uniquely identify the particular thing or act to which it has been attached. The balance of the present inventive method keys off these identifiers. It therefore makes sense to illustrate a variety of suitable identifiers. These are shown in FIGS. 11 and 12.

FIG. 11 shows several identifiers 10 in the form of a stick-on label. The upper identifier 10 has a bar code 12 printed over hologram background 16. Alphanumeric sequence 14 may also be provided, so that a user can read the unique identifier even if no bar code scanner is available. The identifiers preferably indicate authenticity by their very nature. As an example, the use of a hologram suggests to one viewing the product that the identifier is a complex and tamper-resistant device. Thus, even without interacting with the process control system, a person viewing the identifier has an initial impression that the identifier is authentic.

The identifier preferably includes features that prevent alteration and prevent the identifier being removed from one thing and placed on another. The middle view in FIG. 11 shows such a feature. The identifier shown is a stick-on label having a layered structure which is altered when the label is removed. Peel-altered region 18 is visually altered by peeling, so that a user will readily see that the label has likely been removed from one item and placed on another.

The lower view in FIG. 11 shows another embodiment of a stick-on identifier. The version shown is thin metal foil, having a printed alphanumeric sequence and another hologram background 16. While easily applied, such an identifier is very difficult to remove without tearing.

Many other types of identifiers are possible. FIG. 12 shows several more examples, which are suitable for application to different parts of a controlled process. The upper identifier shows an adhesive substrate 20 with other features. It includes a hologram 22 (to provide a first visual indication of authenticity). It also includes an attached RFID chip which contains the unique alphanumeric sequence. It cannot be “read” by the eye, but can be read by a radio frequency scanner.

The next example in FIG. 12 is a plastic tag. It includes a tab which can be looped around an object and then secured via melted joint 26. A bar code 12 is then stamped into the plastic to provide the unique alphanumeric identification. Such an identifier can be attached to the handle of a paint can or similar item.

The next identifier is a stick-on label on the bottom of the finished product itself (in this case a toy train). The finished product preferably includes an identifier so that a user can take a product directly off the store shelf, enter the identifier, and thereby obtain the item's entire product history all the way back to the raw materials that were used to make it. The identifier actually placed on the product in some instances needs to be smaller and more discrete than a bar-code label.

FIG. 12 also depicts an example of a non-physical identifier 10. Many components within a controlled process are not physical items. As an example, one of the components defined in the controlled process may be for a paint manufacturer to test each batch of paint upon completion and prior to placing the paint into cans for shipment. The process controller preferably has knowledge regarding approximately when the paint batch should be completed. A software prompt is sent to a computer located within the facility of the paint manufacturer. It causes a graphical display such as depicted in FIG. 12 to appear. The “identifier” in this instance is a piece of computer software rather than a physical item. Alphanumeric sequence 14 has been assigned to the paint batch and the paint manufacturer is required to respond (“yes” or “no”). If a “no” response is given, a message such as “Testing must be completed within 48 hours to ensure timely delivery of paint.” If a “yes” response is given, then additional questions are asked to obtain the paint lot number, anticipated shipping date, etc.

The software prompt need not be confined to a stationary computer. The inventive process contemplates the use of portable devices such as PDA's. These could be carried by persons working on the factory floor. An action prompt could then be responded to by a variety of methods. If the process sends a query asking whether a batch of paint has been tested yet, the system definitions could accept the answer “yes” being typed on the keyboard of a PDA. On the other hand, if process control requires further definition, the person holding the portable device could be required to photograph the testing in progress and transmit the digital photo along with a scan of a unique identifier identifying the batch of paint.

The system assumes that the data will likely be transmitted from a fixed location having a fixed URL address. However, an entity working within the system could still use a local wireless network and PDA's to funnel the data collected to a central location. The central location would then collect the data and transmit it using the correct URL.

The unique identifiers themselves can be provided in a variety of ways. The company who owns the product being manufactured could furnish them. As an example, a manufacturer of toy dolls could provide the identifiers to each of its vendors involved in the process. The vendors would then be responsible for installing the identifiers. On the other hand, the company owning the product could provide a specification for the identifiers (including the alphanumeric codes assigned) and have the identifiers supplied by a third party or the vendors themselves.

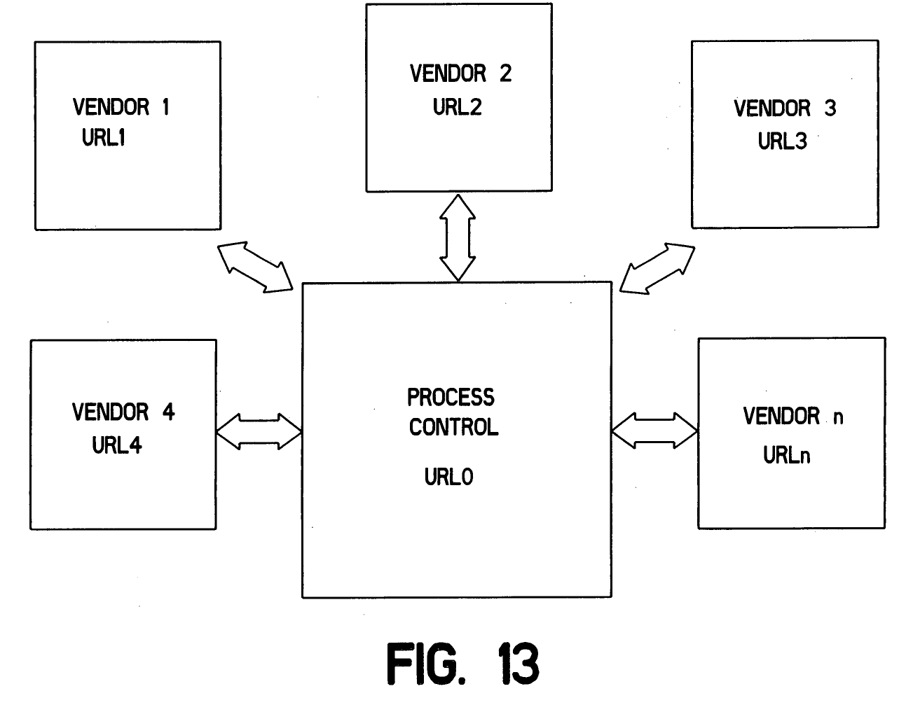

An important concept in the present invention is that the company managing the process control will not be performing most of the steps controlled by the process. Instead, multiple independent vendors will be prompted to take actions, report results, etc. FIG. 13 graphically depicts this concept. “Process control” means a centralized data collecting point that manages the present inventive method. Computer software running on a server or servers is incorporated in the process control, which preferably resides at a fixed communication point (which may be multiple communication points that collect data and feed to a central point). Multiple vendors (Vendor1, Vendor2, Vendor3, etc.) communicate with process control.

Each point in this communication network preferably has an associated Uniform Resource Locator (“URL”). Those skilled in the art will know that a URL defines the location of a particular computer in the worldwide communication network known as the Internet. Process control is denoted as “URL0.” Each vendor has a URL which is known to the process control (URL1, URL2, URL3, etc.).

When process control sends a prompt (such as a query regarding whether a batch of plastic parts has been received from a molder), the prompt is sent to a specific URL and a reply will only be accepted from a specific URL. Thus, if an assembler attempts to outsource certain work to a different physical location, process control will immediately see that the reply has come from the wrong place.

The use of the URL-specific communications also allows process control to check one vendor's responses against another. As an example, process control will know the ship date for components from one vendor to another and the anticipated receipt date. The use of the URL-specific communications allows process control to verify that a batch left the appropriate first physical location, arrived at the appropriate second physical location, and took an appropriate amount of time in transit.

Process control may also link communications to a specific computer at a specific URL by including the computer's Central Processing Unit Identification (“CPUID”) in the verification scheme. This would add another level of security, since process control would only exchange communications with one specific computer.

The reader may at this point benefit from a brief discussion of the type of communication between process control and the various vendors. Many forms are possible. As a first example, each vendor could be required to load and maintain a dedicated piece of software specifically configured to communicate with process control. The data could then be encrypted prior to transmission. While effective, this approach can be limiting since updates to the computers and operating systems may not be compatible with the dedicated software.

Another approach is to use so-called “open source” software for the communication, as is now commonly used over the Internet. Examples include HTML, XML, and CSS. Almost all computers are now equipped to use these protocols through some type of Web browser. Thus, communication links can be established between process control and computers within the vendors' facility without adding additional code and complexity. Such open source exchanges tend to perform well through operating system updates too.

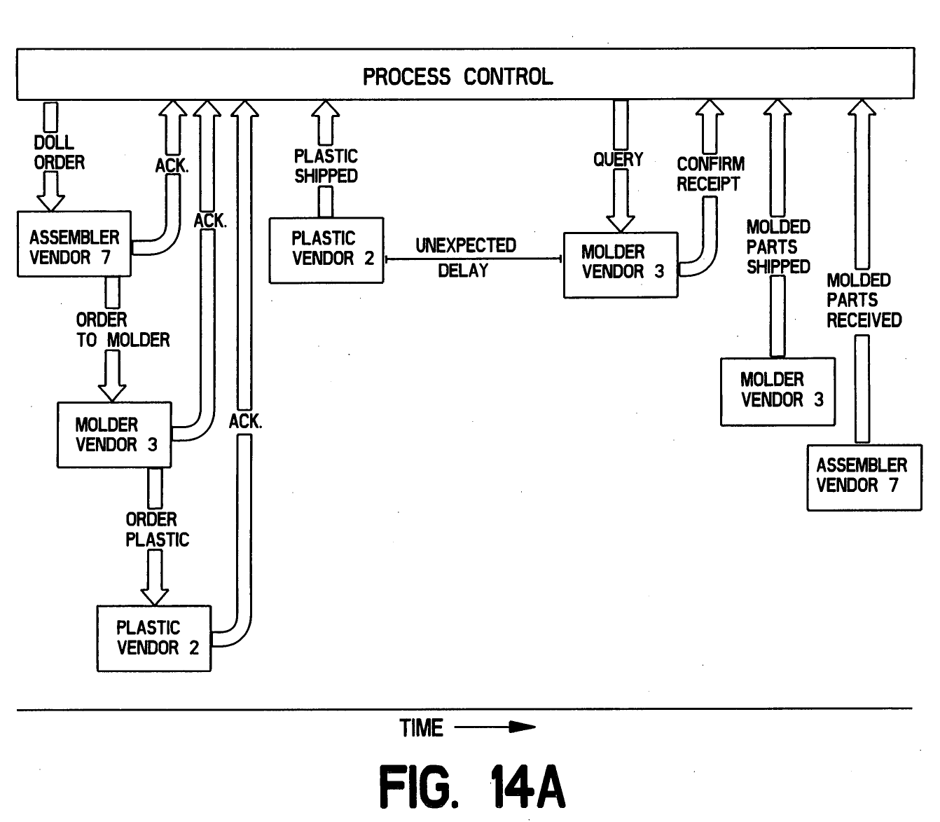

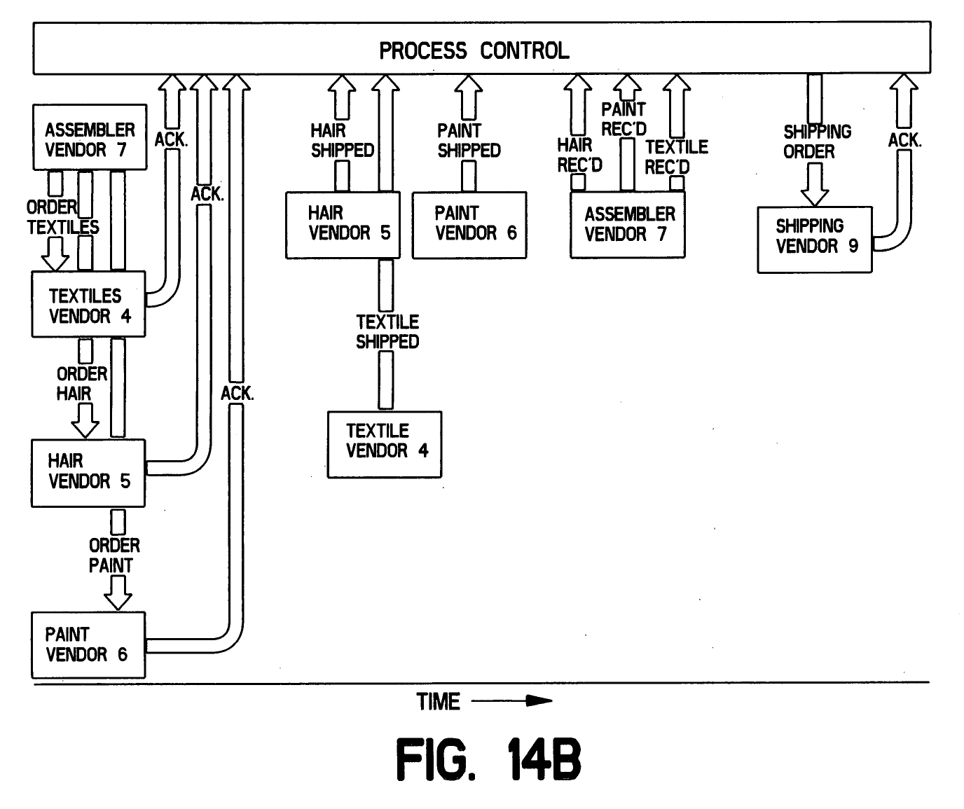

While it is impossible within the scope of a patent application to show how the present inventive method could apply to every manufacturing process, a few examples will aid the reader's understanding. FIGS. 14 through 16 illustrate one way the inventive method could be applied to control the manufacturing and ultimate delivery of a toy doll.

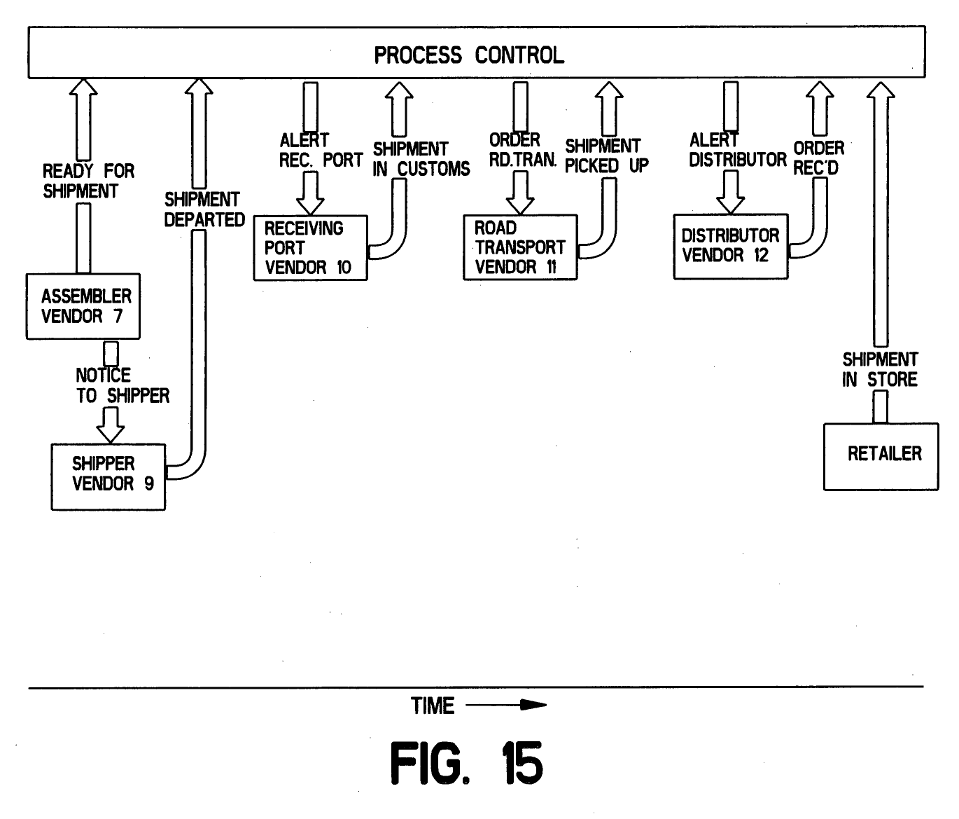

FIG. 14A is a schematic view of the process. Process control is depicted as a bar running across the top of the figure. “Process control” in this instance is software running on a server located in a facility controlled by the company that is marketing the toy doll (“the marketing company”). The marketing company is ultimately responsible for the safety and success of its product. Thus, it wishes to monitor as many of the steps needed to complete the dolls as it possibly can. Passing time moves from left to right in the schematic view. Thus, an action shown on the left side of the view occurs earlier than one shown on the right. FIGS. 14B and 15 are continuations of FIG. 14A, moving further forward in time.

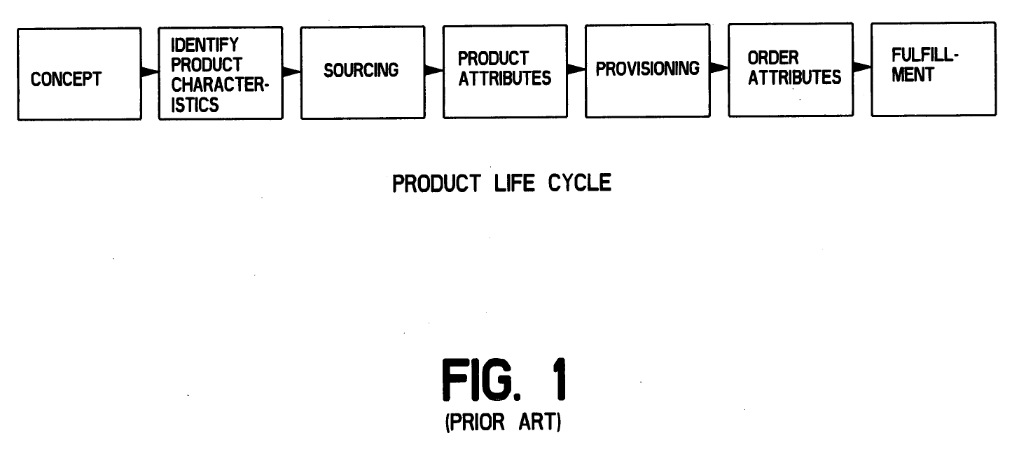

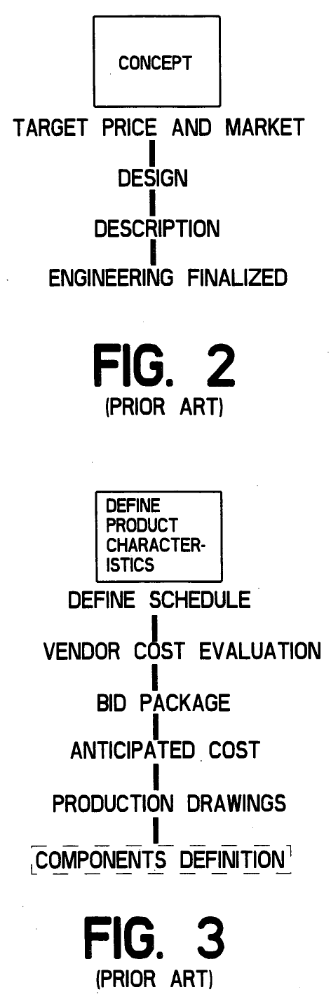

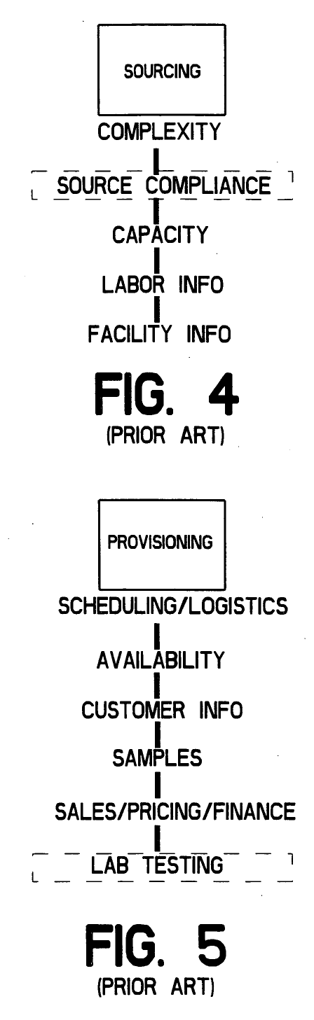

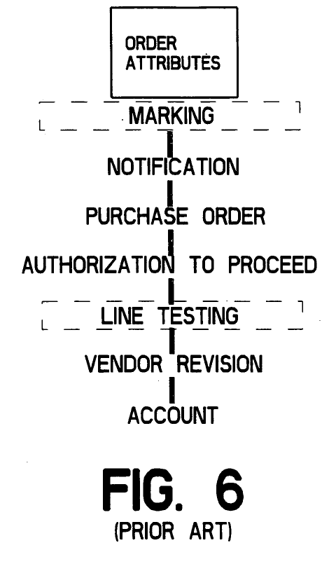

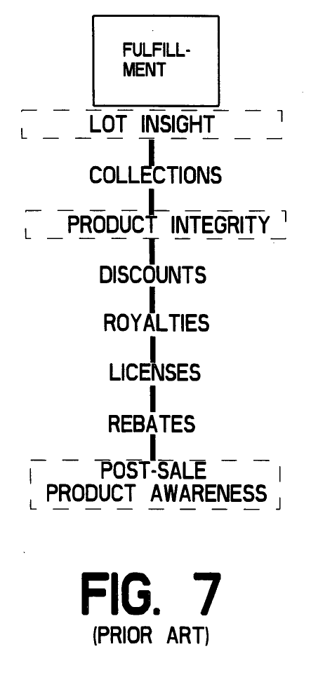

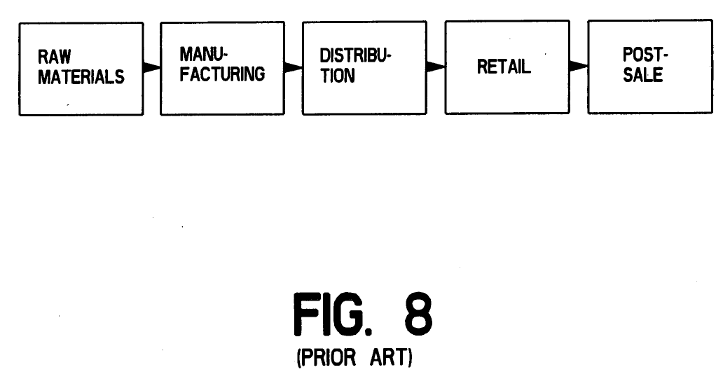

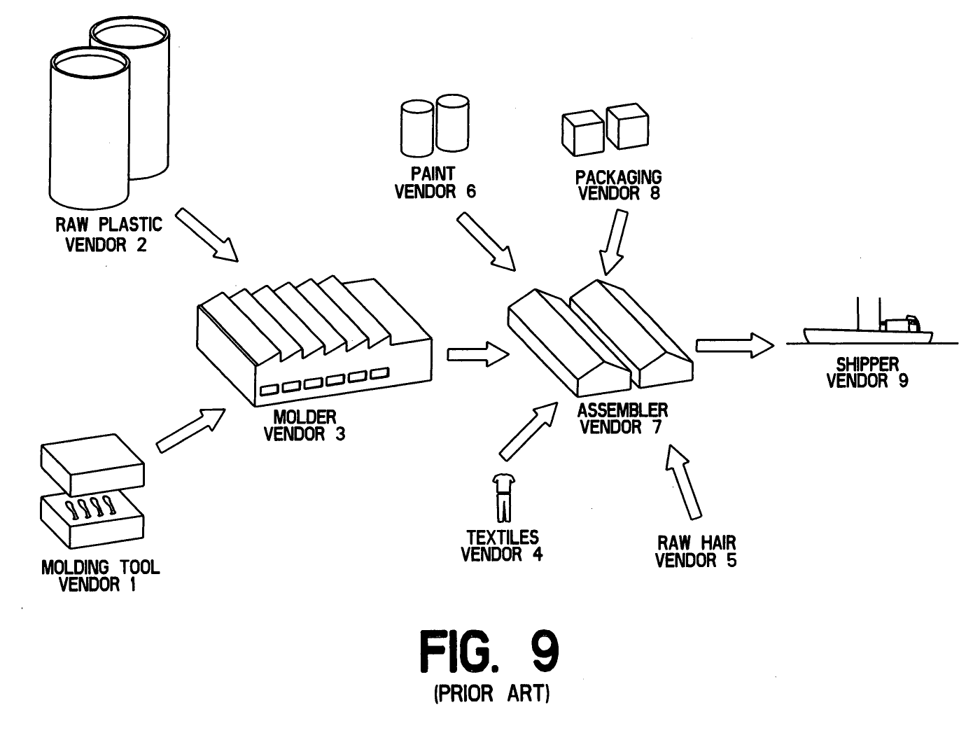

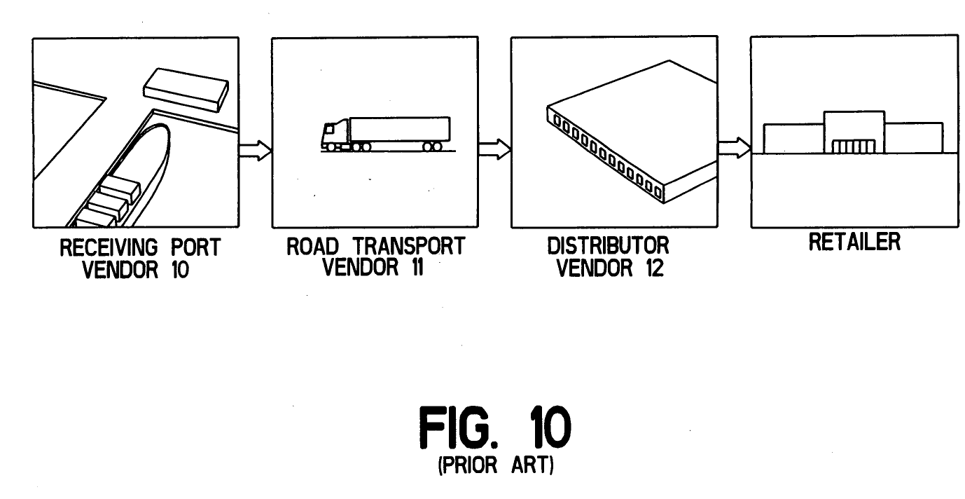

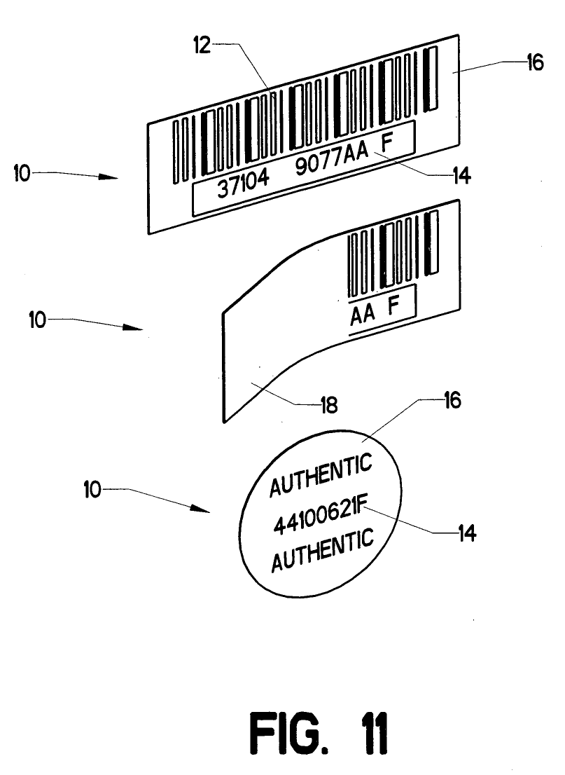

The schematic view only covers a small part of the product life cycle shown in FIGS. 1 through 7. It assumes that the product is already in production and just tracks the placement of an order through a delivery to a retailer. The process starts when the marketing company receives an order for a specified number of dolls for delivery to a retailer. The marketing company enters this order into the computer system running the process control scheme (including all the order attributes previously defined). Process control then sends a doll order to an assembler (Vendor 7) as shown on the left side of FIG. 14A. Vendor 7 sends an acknowledgement back to Process control, which notes that the order has been received and is in process.

Vendor 7 then begins taking actions it must perform in order to fulfill its responsibilities. As an example, it needs molded plastic doll parts in order to assemble the dolls. As this is the component of the assembly having the longest lead time, Vendor 7 starts by sending an order for molded parts to a molder (Vendor 3). Vendor 3 acknowledges receipt of this order back to process control.

Vendor 3 next orders raw plastic aggregate for use in the molding process. This order is sent to a plastic supplier (Vendor 2). Vendor 2 sends an acknowledgment of this order back to process control. Thus, process control sees that its original order to Vendor 7 has created an appropriate “ripple” of acknowledgements from different vendors. Process control can therefore monitor the fact that the process is thus far proceeding as it should.

The next occurrence is the plastic supplier (Vendor 2) sending a notice to process control that the plastic aggregate has been shipped to Vendor 3 (the molder). The method preferably has built-in knowledge regarding how the process should proceed. It therefore “knows” what action should take place and when it should expect to see that action. As an example, process control has the knowledge that the plastic vendor is located on the west coast of the United States and the molder is located on the east coast of China. The system also knows that surface freight is supposed to be used for the shipping. It will therefore expect a notice that the plastic has been received by the molder 21-24 days after receiving the notice that it has been shipped by the plastic supplier.

In this example, however, no notice of receipt reaches process control by the 25th day. Process control is preferably configured to be proactive. It is programmed to prompt corrective action when a deviation from the anticipated process is observed. Thus, process control sends a query to the molder (Vendor 3). This query can assume many forms. One good way to perform the query is to have a text box appear on the designated computer at Vendor 3's facility. This text box directs Vendor 3 to determine whether the plastic has arrived and to inform process control.

The reader will recall that each item and identified step in the process is given an identifier 10. Thus, each drum of plastic aggregate has been given an identifier such as a stick-on label with a bar code. In this example, the identifier has been placed on the drums by the plastic supplier. Vendor 3 sends an employee down to its receiving bay. The employee preferably has a hand-held device which incorporates a scanner and the ability to communicate with the designated computer within Vendor 3's facility.

The employee searches and locates a group of plastic drums banded on a pallet. He scans the identifiers. The computer within Vendor 3's facility receives this information and transmits it to process control. Process control then matches the drum identifiers against those shipped by the plastic vendor. If there is a discrepancy, process control notifies Vendor 3.

In this case no discrepancy is noted so the process proceeds with a confirmation that the plastic has been received being sent from the molder to process control. The molder uses the plastic aggregate to mold the doll parts. It then packages the molded parts and applies identifiers to each box of parts. The parts are then shipped to the assembler. At the time of shipment, the molder (Vendor 3) sends a shipment notification to process control. This shipment notification typically would include details regarding the number of parts shipped, the number of containers used, and the identifiers used.

The inventive method is customizable to suit whatever information a particular company wants to track. For example, a box of 1000 doll torsos might not have individual serial numbers for each doll torso, but instead just a lot number. But, this lot number could be associated with data showing when the torsos were made, what vendor made them, what plastic was used, etc.

Process control having received notification that the molded parts were shipped by Vendor 3 to Vendor 7, process control “anticipates” receiving confirmation of receipt from Vendor 7. In the example, this confirmation that the molded parts have been received is indeed timely provided to process control, as shown in the right hand side of FIG. 14A.

FIG. 14B continues the example of FIG. 14A, moving further forward in time. The assembler having received the long-lead items (molded plastic parts), orders are then placed for short-lead items. Vendor 7 orders textiles from Vendor 4, hair from Vendor 5, and paint from Vendor 6. Vendors 4, 5, and 6 each send an acknowledgement back to process control. At the time Vendors 4, 5, and 6 each ship their respective products to the assembler, a shipment notification is sent to process control (as shown in the view).

Likewise, when the assembler receives each of the hair, textile, and paint products, it sends a notification of receipt to process control (also shown in the view). The knowledge built into the process then indicates that the dolls will soon be completed (since all the components have arrived at the assembler's facility). Process control is configured to monitor and govern a process that is defined by the marketing company. Under the definition used in this example, the marketing company is actually responsible for arranging shipping across the Pacific Ocean. Having received the notification that the molded parts have been delivered to the assembler, process control anticipates completion and packaging of the toy dolls within 7 days. Thus, process control sends a shipping alert to a shipper (Vendor 9). The shipper acknowledges receipt of this order in the far right portion of FIG. 14B.

FIG. 15 continues the example moving further forward in time. The assembler (Vendor 7) sends a notice to process control that the parts are ready for shipment. Vendor 7 also sends an order to the shipper (Vendor 9). The shipper then sends an acknowledgement that the shipment has departed back to process control.

Approximately seven days before the anticipated arrival of the shipment, process control sends an alert to the receiving port (Vendor 10) providing information regarding the ship carrying the goods and its anticipated date of arrival. A few days later, the receiving port sends a message to process control stating that the goods have arrived, have been offloaded, and are in customs. Process control then sends an order to a road transporter (Vendor 11) instructing the road transporter to proceed to the receiving port and pick up the goods.

Once the road transporter has picked up the goods, it sends a notification to process control that the goods have been loaded onto a truck and are in transit. Process control then sends a notice to alert the product distributor (Vendor 12). Once the goods reach the distribution center, the distributor sends an acknowledgement to process control. The distributor then sends individual lots to retailers, who each send a message to process control stating that the goods are received and will be stocked on the shelves.

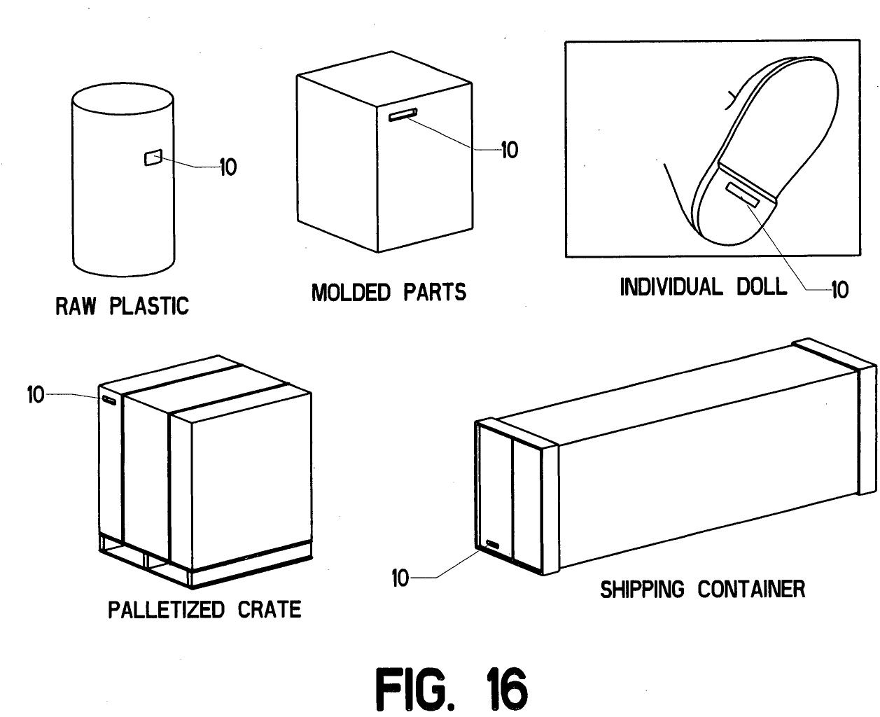

Throughout the steps described in FIGS. 14 through 15, the unique identifiers were used to verify the authenticity of the communications and the actions taken. FIG. 16 shows some of the types of identifiers which could be used. A drum of raw plastic has a stick-on identifier 10. The alphanumeric code on this identifier is associated with data revealing the name of the manufacturer, the location where the plastic was made, the date the plastic was made, etc. The plastic vendor scans this identifier as the shipment leaves and the molder again scans the identifier when the shipment is received.

The molded plastic components (such as arms, legs, and torsos) are packed into a box (shown in the upper middle view). This box is given another stick-on identifier. This identifier is scanned by the molder as the components are sent to the assembler and scanned by the assembler when they are received.

The toy doll itself is preferably also associated with an identifier, which can be placed on the doll or on the doll's packaging. The upper right view in FIG. 16 shows the placement of a small identifier 10 on the heel of the doll. An RFID tag could also be embedded within the doll or some of the doll's clothing.

Once the dolls are assembled and placed into individual packaging, they are collected and crated onto a pallet. This crate is then given still another identifier 10, as shown in the lower left view of FIG. 16. Dozens of similar crates are then placed within a shipping container, which is given still another identifier. All of these identifiers are scanned during the reporting steps to process control. The term “scanned” should be broadly understood to include the use of hand-held scanning devices, stationary line scanners, and even the simple act of a human user reading the alphanumeric code and speaking it into a voice recognition system or typing it on a conventional keyboard.

However the alphanumeric code is read, the important concept is the fact that it is provided to process control and thereafter used to monitor the progress of the defined process. It may therefore be helpful for the reader to understand on a scan-by-scan basis, how the steps described in FIGS. 14-15 take place. The process being monitored must first be defined (generally by the marketing company). The definition preferably includes substantial detail, including vendor locations, shipment timing, etc. This definition is used to create rules which then dictate actions. For example, the definition should include the fact that obtaining the molded plastic parts from the molder will take much longer than obtaining the paint from the paint vendor. A rule is then created which says “When an order for dolls is received, the assembler should first order the molded plastic parts from the molder.”

A user interface which allows these rules to be created using natural language is preferable. Click-and-drag block diagrams may also be used (which will be familiar to those skilled in the art). Another rule found in the example of FIGS. 14-15 would be “If the molder has not acknowledged receipt of the plastic aggregate within 24 days of when the plastic vendor shipped the plastic aggregate, then query the molder.”

The definition is preferably improved and refined over time. The example assumes that the marketing company is responsible for obtaining shipment of the products across the Pacific Ocean. Actual experience with running the process may reveal that if the shipper is notified at the point where all the materials are present in the assembler's facility, the toy dolls will be completed and ready to ship before the shipper's land transport vehicles arrive at the assembler. Thus, a rule could be created which states: “When all components are known to be present in the assembler's facility, contact the shipper and place the order for shipment.”

Many of the rules governing the actions of process control will need to be created by people understanding the process. However, some automated rule creation will preferably also be provided. In its simplest form, this would be software which tracks performance of the steps over time and refines the expectations of when certain steps will be completed. As an example, the molder's turnaround time will likely improve as more experience is obtained with molding the particular doll components (set-up time typically being reduced as experience is gained). Process control might initially expect to receive a notice that the molded parts have been shipped within 14 days of the assembler placing an order with the molder (and a rule would be created accordingly). However, after a year of production runs, the actual recorded timing shows that a notice of shipment is being received on average 9.3 days from the notice of the placement of the order, with less than 10% of the orders exceeding 11 days. Process control might then change the rule to expect a notice of shipment within 11 days instead of 14. A record of this change—along with the motivation underlying it—would be stored within the database available to process control.

A discussion of the use of the identifiers in the examples of FIGS. 14-16 will now be provided. The reader will recall from the discussion of FIGS. 11 and 12 that the identifiers can be physical things (such as stick on labels and tags) or non-physical things (such as the computer-based prompt shown in FIG. 12).

Returning now to FIG. 14A, the first action taken would be process control sending the doll order to the assembler (Vendor 7). The order preferably appears as a display on the computer monitor designated in Vendor 7's facility. A unique alphanumeric identifier is associated with the order. The display prompts an acknowledgement, which is also assigned a unique alphanumeric identifier. The performance of these steps are recorded in the database available to process control, along with the associated identifiers. Similar displays on computer monitors are created for the orders to the molder and the plastic vendor, along with the associated acknowledgements.

The plastic vendor introduces the first physical identifier in this example. As explained previously, the physical identifiers could be furnished by process control, or made available through a regulated third party. In this example, process control has assigned a series of 1,000 stick on labels with embedded alphanumeric sequences to the molder (Vendor 3). The molder is to use these in sequence as plastic is shipped for use in the marketing company's products.

When the plastic is ready to ship, the plastic vendor affixes a stick on label to each drum and scans these with a hand-held device. Process control then provides a series of questions. For example, the plastic vendor may be required to enter the type of plastic, the date manufactured, the pigment, etc. All this information is then associated with the identifier that is physically placed on the drum. The association is stored in the database available to process control.

When the molder receives the drums of plastic, the identifiers attached thereto are again scanned. Process control checks the data received against the data already stored to ensure that the drums are the same ones that left the plastic supplier.

When the molder completes the run of molded parts and boxes them for shipment, the molder affixes an identifier to each box (using a series of stick on identifiers previously provided by process control). These are scanned and relevant data is again associated with each identifier. The same process is used for each of the vendors. Each will affix physical identifiers to the items it ships or receives. Likewise, a non-physical unique identifier will be assigned to each step completed by each vendor.

The same is true for the shipping and distribution portions of the process. Each step to be performed is included in the definition of the process, and each physical item which exists at any point is included in the definition. The reader should note that some physical items will be transitory. An example would be a can of paint which is delivered to the assembler but consumed in the manufacturing process. This will obviously also be true for packing crates and similar items.

By following this method, a complete history of all items used and all steps created will be obtained and stored in the database accessible to process control. This data can be used for a myriad of purposes, including: (1) tracing the product history in the event of a product defect; (2) optimizing the timing of orders and shipping; and (3) comparing the actions of competing vendors.

The reader should note that the linear processes illustrated in FIGS. 14-15 are no longer commonly used in industry. “Just in Time” manufacturing is now used instead. Under that scheme, all vendors are expected to anticipate orders for their finished products and maintain relationships with their material suppliers so that materials arrive just as they are needed and manufactured goods are delivered just as they are needed in the next stage of the process. Thus, as an example, it would no be typical for a plastic molder to sit idle for three weeks awaiting the arrival of plastic aggregate from overseas.

The more old-fashioned linear process example was presented because it is easier to follow. However, the present inventive method can also apply to “Just in Time” manufacturing. The rules governing the timing become more complex, but such rules are readily understood within the art. As an example, the molding vendor will be expected to order appropriate plastic stocks to have the material on hand as the order for molded parts arrives. Thus, process control would not see an order for plastic being placed or use in molding the toy dolls just ordered. However, the molder will need to replace the stock it is using so that it will be ready for the next “Just in Time” order. Thus, the molder will be expected to place a new order for plastic. This fact can be used to create a rule which monitors for the molder ordering replacement plastic.

Process control is also preferably given flexibility. Continuing with the “Just in Time” example, some flexibility may be needed. Assume that the toy dolls in question are to be painted. They are molded in a pliable plastic having a neutral color. The molder may use this particular plastic for products going to several different companies. If the marketing company orders toy dolls, then the existing rules will monitor for an order for new plastic from the molder. When this order is not seen, a query is sent from process control to the molder. The molder responds by explaining (in text communicated over the Internet) that it has reached the end of a contract for another company which used the same plastic compound and therefore currently has too much of this compound in inventory. The rules in process control can be modified to reflect a temporary suspension of the expectation of plastic orders.

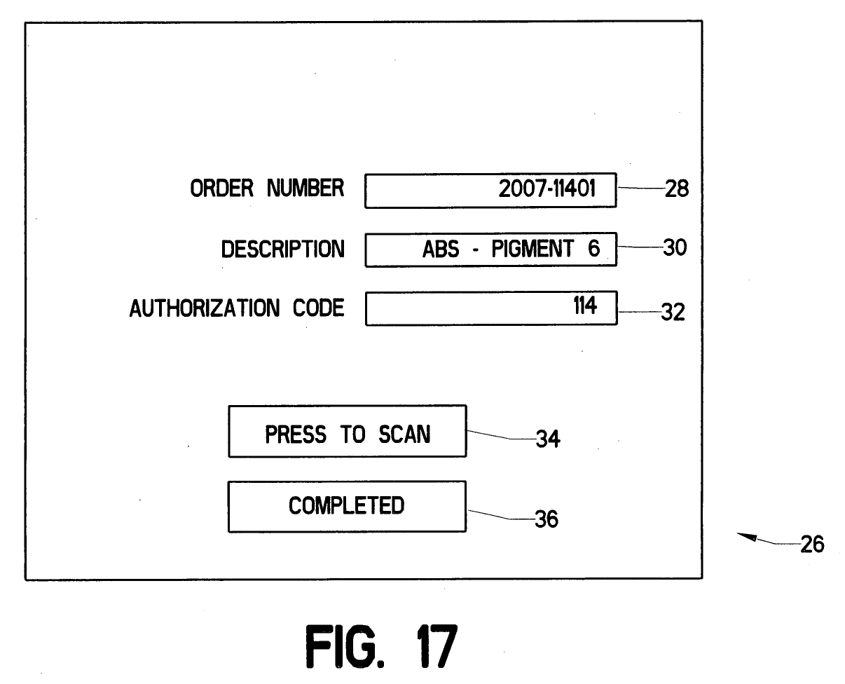

It is therefore important to understand that process control is preferably not a static thing. It should instead be relatively easy to refine and update. Process control preferably interacts with the vendors and the users through a graphical user interface (a “GUI”). Those skilled in the art will know that a GUI can assume an endless variety of forms. FIGS. 17-22 illustrate one possible GUI, along with some of the features the process control preferably provides.

FIG. 17 shows a portion of graphical user interface 26. It displays information which would be presented to a plastic vendor for completion. Order field 28 contains an order number provided to the vendor by process control. Description field 30 contains a description of the item ordered—a quantity of ABS plastic having a certain pigment. Code field 32 contains a code issued by process control authorizing shipment of the plastic (the issuance of such a code being part of the process definition in this example).

Authorization prompt 34 prompts the user to scan the identifier affixed to the drum containing the plastic. The user then uses a handheld or remote device to scan the identifier. If the scanned data is appropriate (i.e., consistent with what process control expects), then success indicator 36 is displayed. If the scanned data is inconsistent, a different prompt is provided.

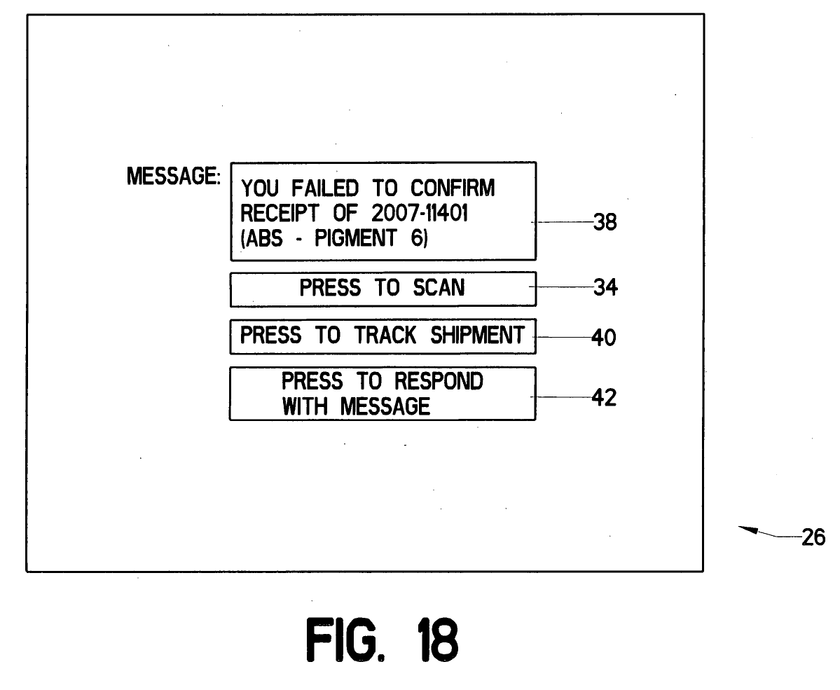

FIG. 18 shows a display of the message sent by process control to the molder in FIG. 14 (when the molder was late on reporting receipt of the plastic). Message field 38 informs the molder that an anticipated act was not performed. The molder is then given several options. If the molder has received the plastic and forgotten to inform process control, then an employee presses authorization permit 34 and scans the identifier attached to the drums of plastic. If the molder has not received the plastic, the employee picks tracking prompt 40, which initiates a tracking search using the shipping information previously provided to process control. If the molder has an unusual problem requiring further interaction, then reply message prompt 42 is pressed. This action allows the molder to furnish an explanation of the situation and seek further instructions from process control.

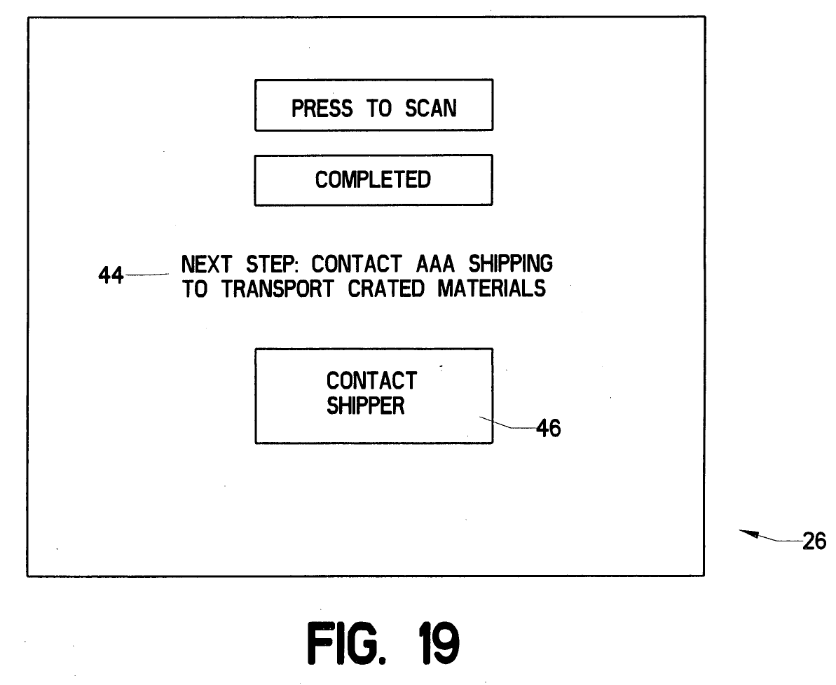

FIG. 19 shows a portion of the GUI that would be presented to the assembler once the products are completed and ready for shipping. The assembler is prompted to scan the relevant identifiers. A “completed” notice is then provided to indicate successful receipt of matching identifiers by process control. The GUI preferably provides prompting information regarding the next action that needs to be taken. Step description 44 informs the assembler that the appropriate next step is to contact the shipper. Action prompt 46 is provided to automate the contacting of the shipper.

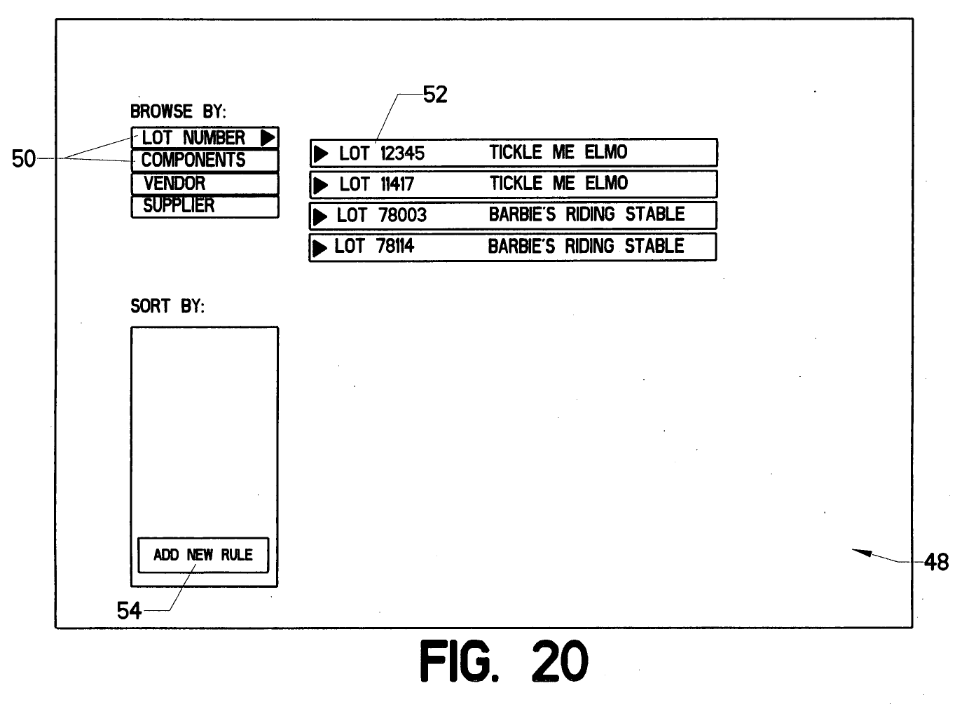

If the inventive method is utilized throughout the product life cycle, then a great deal of data is collected and stored by process control. This data can be useful for many purposes. A GUI is preferably also provided for use by employees of the marketing company. FIGS. 20-22 show one example of what such a GUI might look like, with the GUI being designated as process control user interface 48. FIG. 20 presents a top-level display. The user is given browse options 50, which allow the user to select a variety of search methods. As an example, the user can perform data searches according to lot number, item number, components used, vendor, etc.

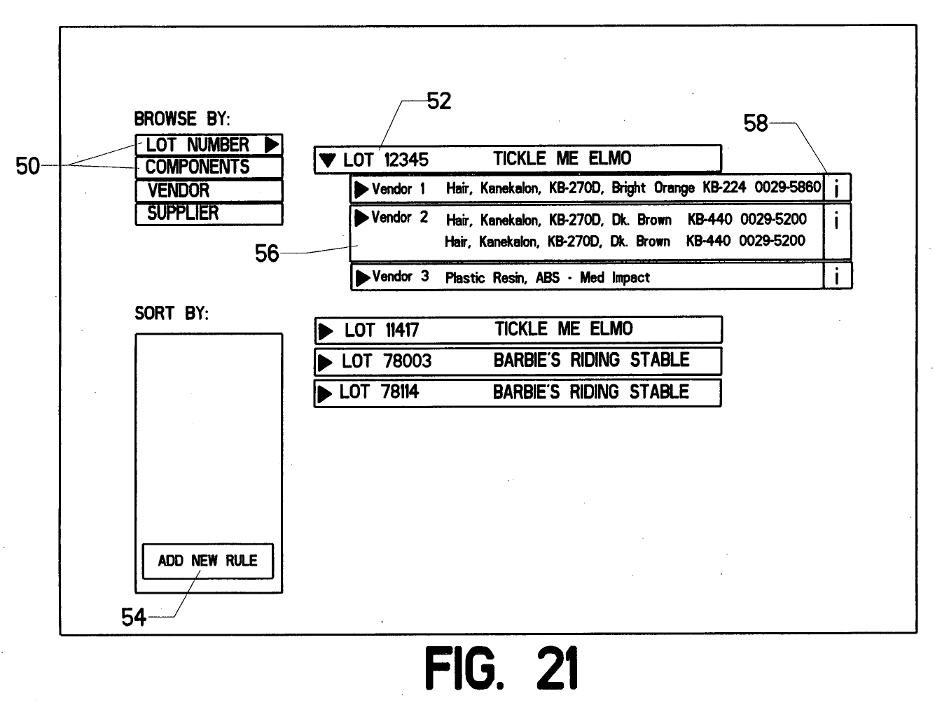

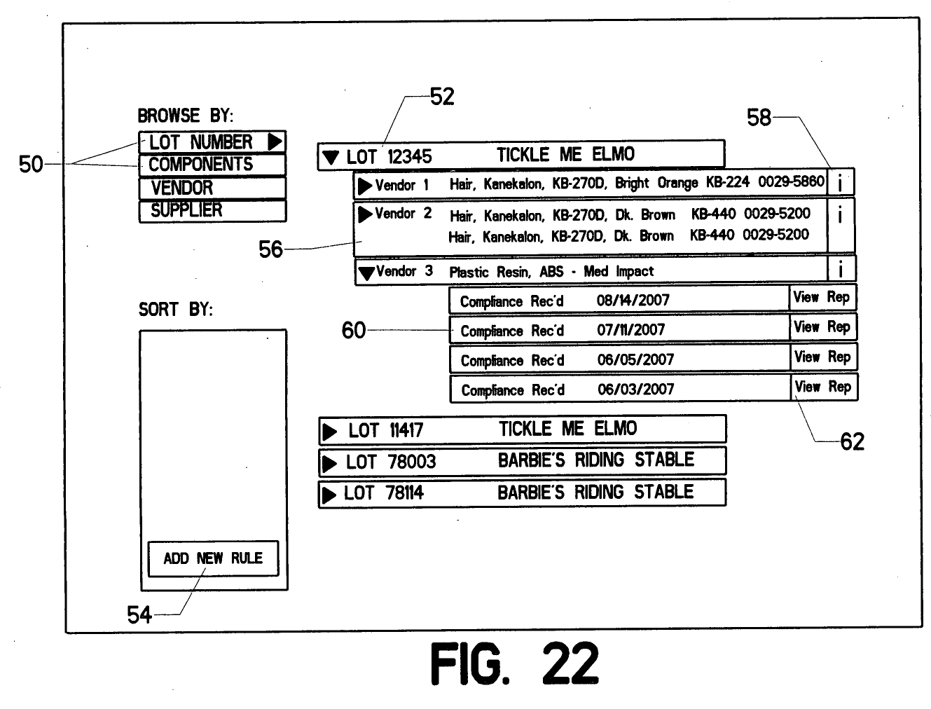

In FIG. 20, the user has elected to search by lot number and a listing of lot data 52 has been retrieved. If the user then picks “Lot 12345,” a new display such as shown in FIG. 21 appears. Vendor data 54 and supplier data 56 appears for each lot, along with descriptive information. Cross links 58 are provided to related lots. The GUI includes a series of layered menus which allow a user to drill deeper and deeper into the available data. If the user picks the text “Supplier 2” in FIG. 21, then a display such as shown in FIG. 22 appears. Compliance history 60 is shown, which shows the most recent scans of identifiers attached to drums of plastic resin.

The user can actuate a report link 62 to view the details of a particular step in the production process. A report might, for example indicate that on Sep. 15, 2007, a query was sent to the plastic supplier regarding a shipment, a confirming scan of a series of identifiers was performed, and an acknowledgement sent back to process control. Similar layered menus are preferably provided for all the data collected by process control.

The reader may wish to know how such capabilities can be applied in an actual situation where a problem has been discovered with a toy doll. In this example, a retailer has discovered that a doll on its shelves is painted with paint containing an unacceptable level of lead. The retailer contacts the marketing company. The marketing company obtains the alphanumeric code on the identifier attached to the problematic toy doll. This identifier is then fed into the process control GUI. A user can then sort through the data collected to find out: (1) The identity of the assembler; (2) The identity of the paint supplier that supplied paint to the assembler; (3) The lot number of the paint actually used; and (4) The compliance testing that was allegedly performed on the paint and by whom (These are examples of the type of information available. Other information may be available as well).

Further, the user can then search the database of all its toys to see which other toys may have been painted with the same contaminated lot of paint. This will allow a targeted recall of only those products actually containing the contaminated paint. Thus, the inventive method provides a comprehensive database containing all needed information regarding the history of a particular product. This information allows the marketing company to take appropriate corrective action without needlessly recalling unaffected products.

One useful embodiment of the inventive process can therefore be summarized as follows:

1. Defining the production process by (a) defining the product; (b) defining all the actions needed to make the product; (c) identifying all the vendors who will participate in making the product; (d) assigning to each vendor the steps in the process for which they are responsible—including physical items and actions to be taken; (e) defining which of the physical items and/or which of the steps in the process the user wishes to track (One could track every item and every step but this may be unnecessary in many applications);

2. Establishing a process control. This is a data receiving and analysis function that may be carried out by the vendor or contracted to a third party service provider. The process control can be a server with an associated database. Sine communications are preferably carried out over the Internet, the process control server will have one or more associated Uniform Resource Locators (“URL's”) it uses to receive data from the vendors;

3. Providing a unique identifier for every physical item identified in #1(e) above (Examples of physical items include molded plastic parts, raw materials, paint, etc.);

4. Providing a unique identifier for every step identified in #1(e) above. (Examples of steps include mixing a custom paint, molding a particular part, etc.). The unique identifier for a step could be something like a code that is generated and transmitted to the vendor's designated URL. The vendor must respond appropriately to this code and indicate that the step is completed (thereby making it difficult for the vendor to subcontract the activity without the knowledge of process control

5. Issuing the appropriate unique identifiers for the physical items and the steps to be performed to the appropriate vendors. For physical items; the vendor is preferably required to affix the unique identifier to the physical item;

6. Providing an established communication protocol between each vendor and process control so that authorized communication for each vendor only takes place through the communication protocol. One example would be specifying URL's to be used for transmitting and receiving. Additional control can be provided by specifying a particular CPU ID which the vendor must use for communications;

7. For each physical item, requiring the vendor to “read” the unique identifier on that physical item and communicate the item type, the unique identifier, and the vendor identification information to process control through the established communication protocol.

8. For each communication received by process control, verifying that the item type, the unique identifier, and the vendor ID info are all appropriate.

9. Creating a database which stores all the (appropriate) information needed to determine what physical items went into the final product, what steps were performed, and by whom.

Once the database is built, the unique identifier(s) found on the completed product can be used to determine virtually any information that is needed. By entering one unique identifier in the database, the database will provide all physical items associated with that unique identifier, all steps performed, and every vendor that participated in creating the product. Of course, some of the associated items may be “lot numbers” rather than individual parts. The user can decide how much detail is desired and configure the inventive process to provide that level of detail.

The preceding description contains significant detail regarding the novel aspects of the present invention. It should not be construed, however, as limiting the scope of the invention but rather as providing illustrations of the preferred embodiments of the invention. As an example, many different types of identifiers could be substituted for the examples actually illustrated. Accordingly, the scope of the invention should be fixed by the following claims, rather than by the examples given.

Having described my invention, I claim:

1. A method allowing a user to manage a production process involving a plurality of vendors, said production process being used to create a product, comprising:
a. defining said production process, wherein said definition includes
i. defining said product,
ii. defining all the actions needed to make said product,
iii. defining all the physical items needed to make said product,
iv. defining all the vendors who will participate in making said product,
v. assigning to each vendor the actions which must be taken by said vendor and said physical items which will be associated with said actions,
vi. defining which of said physical items said user wishes to track;
b. providing a process control capable of receiving data from said vendors;
c. providing a unique identifier for each of said physical items said user wishes to track;
d. providing said unique identifiers for each of said physical items to said vendors, with each of said unique identifiers for said physical items being provided to the appropriate one of said vendors;
e. affixing the appropriate one of said unique identifiers for said physical items to each of said physical items said user wishes to track;
f. providing a defined communication protocol between each of said vendors and said process control which provides vendor identification information, so that authorized communication for each of said vendors only takes place through said defined communication protocol;
g. for each of said physical items said user wishes to track, requiring a vendor in possession of said physical item to retrieve data from said unique identifier for each of said physical items on said physical item and communicate said data to said process control over said defined communication protocol;
h. for each of said communications received by said process control, verifying that said unique identifier data for said physical items and said vendor identification information received by process control are both appropriate according to said definition of said production process;
i. providing a database for storing information; and
j. storing said unique identifier data for said physical items and said vendor identification information in said database.

2. A method for managing a production process as defined in claim 1, wherein said step of providing a defined protocol between each of said vendors and said process control comprises:
a. providing a Uniform Resource Locator for each of said vendors;
b. providing a Uniform Resource Locator for said process control; and
c. requiring that data from a particular vendor only be sent from the Uniform Resource Locator assigned to that vendor.

3. A method for managing a production process as defined in claim 1, wherein said step of requiring a vendor in possession of said physical item to retrieve data from said unique identifier for said physical items on said physical item and communicate said data to said process control over said defined communication protocol, further comprises:
a. requiring said vendor to communicate additional data which describes said physical item; and
b. verifying that said additional data describing said physical item corresponds to said unique identifier data for said physical items and said vendor identification information.

4. A method for managing a production process as defined in claim 1, wherein said step of providing a defined protocol between each of said vendors and said process control comprises:
a. providing a Uniform Resource Locator from which a particular vendor is to send data; and
b. providing a Uniform Resource Locator to which a particular vendor is to send data.

5. A method for managing a production process as defined in claim 1, further comprising:
a. defining which of said actions needed to make said product said user wishes to track;
b. providing a unique identifier for each of said actions needed to make said product said user wishes to track;
c. providing said unique identifiers for said actions to said vendors, with each of said unique identifiers for said actions being provided to the appropriate one of said vendors;
d. for each of said actions said user wishes to track, requiring a vendor who is to perform said action to retrieve data from said unique identifier for said action and communicate said data to said process control over said defined communication protocol;
e. for each of said communications received by said process control, verifying that said unique identifier for said action data and said vendor identification information received by process control are both appropriate according to said definition of said production process; and
f. storing said unique identifier for said action data and said vendor identification information in said database.

6. A method for managing a production process as defined in claim 5, wherein said step of providing a defined protocol between each of said vendors and said process control comprises:
a. providing a Uniform Resource Locator for each of said vendors;
b. providing a Uniform Resource Locator for said process control; and
c. requiring that data from a particular vendor only be sent from the Uniform Resource Locator assigned to that vendor.

7. A method for managing a production process as defined in claim 5, wherein said step of requiring a vendor in possession of said physical item to retrieve data from said unique identifier for said physical items on said physical item and communicate said data to said process control over said defined communication protocol, further comprises:
a. requiring said vendor to communicate additional data which describes said physical item; and
b. verifying that said additional data describing said physical item corresponds to said unique identifier data for said physical items and said vendor identification information.

8. A method for managing a production process as defined in claim 5, wherein said step of providing a defined protocol between each of said vendors and said process control comprises:
a. providing a Uniform Resource Locator from which a particular vendor is to send data; and
b. providing a Uniform Resource Locator to which a particular vendor is to send data.

9. A method for managing a production process as defined in claim 1, further comprising:
a. retrieving said unique identifier for said physical items from one particular completed product; and
b. using said unique identifier for said physical items from one particular completed product to access data in said database and retrieve all other physical items in said database which are associated with said unique identifier.

10. A method for managing a production process as recited in claim 5, further comprising:
a. retrieving said unique identifier for said physical items from one particular completed product;
b. using said unique identifier for said physical items from one particular completed product to access data in said database and retrieve all other physical items in said database which are associated with said unique identifier; and
c. using said unique identifier for said physical items from one particular completed product to access data in said database and retrieve all actions in said database which are associated with said unique identifier.

11. A method allowing a user to manage a production process involving a plurality of vendors, said production process being used to create a product, comprising:
a. defining a production process, including a definition of said product, said physical items needed to make said product, and which vendors will have possession of which of said physical items;
b. defining which of said physical items said user wishes to track;
c. providing a unique identifier for each of said physical items said user wishes to track;
d. providing a process control capable of receiving data from said vendors;
e. affixing one of said unique identifiers for physical items to each of said physical items said user wishes to track;
f. providing a defined communication protocol between each of said vendors and said process control which provides vendor identification information, so that authorized communication for each of said vendors only takes place through said defined communication protocol;
g. retrieving data from one of said unique identifiers for physical items and communicating said data to said process control over said defined communication protocol;
h. verifying that said unique identifier data for said physical items and said vendor identification information received by said process control are both appropriate according to said definition of said production process;
i. providing a database for storing information; and
j. storing said unique identifier data for said physical items and said vendor identification information in said database.

12. A method for managing a production process as defined in claim 11, wherein said step of providing a defined protocol between each of said vendors and said process control comprises:
a. providing a Uniform Resource Locator for each of said vendors;
b. providing a Uniform Resource Locator for said process control; and
c. requiring that data from a particular vendor only be sent from the Uniform Resource Locator assigned to that vendor.

13. A method for managing a production process as defined in claim 11, wherein said step of retrieving data from said unique identifier for said physical items on said physical item and communicating said data to said process control over said defined communication protocol, further comprises:
a. communicating additional data which describes said physical item; and
b. verifying that said additional data describing said physical item corresponds to said unique identifier data for said physical items and said vendor identification information.

14. A method for managing a production process as defined in claim 11, wherein said step of providing a defined protocol between each of said vendors and said process control comprises:
a. providing a Uniform Resource Locator from which a particular vendor is to send data; and
b. providing a Uniform Resource Locator to which a particular vendor is to send data.

15. A method for managing a production process as defined in claim 11, further comprising:
a. defining actions needed to make said product, and which vendor will perform each of said actions;
b. defining which of said actions needed to make said product said user wishes to track;
c. providing a unique identifier for each of said actions needed to make said product said user wishes to track;
d. providing said unique identifiers for said actions to said vendors, with each of said unique identifiers for said actions being provided to the appropriate one of said vendors;
e. for each of said actions said user wishes to track, requiring a vendor who is to perform said action to retrieve data from said unique identifier for said action and communicate said data to said process control over said defined communication protocol;
f. for each of said communications received by said process control, verifying that said unique identifier for said action data and said vendor identification information received by process control are both appropriate according to said definition of said production process; and
g. storing said unique identifier for said action data and said vendor identification information in said database.

16. A method for managing a production process as defined in claim 15, wherein said step of providing a defined protocol between each of said vendors and said process control comprises:
a. providing a Uniform Resource Locator for each of said vendors;
b. providing a Uniform Resource Locator for said process control; and
c. requiring that data from a particular vendor only be sent from the Uniform Resource Locator assigned to that vendor.

17. A method for managing a production process as defined in claim 15, wherein said step of requiring a vendor responsible for performing a particular action said user wishes to track to communicate additional data to process control when said step is completed.

18. A method for managing a production process as defined in claim 15, wherein said step of providing a defined protocol between each of said vendors and said process control comprises:
a. providing a Uniform Resource Locator from which a particular vendor is to send data; and
b. providing a Uniform Resource Locator to which a particular vendor is to send data.

19. A method for managing a production process as defined in claim 11, further comprising:
a. retrieving said unique identifier for said physical items from one particular completed product; and
b. using said unique identifier for said physical items from one particular completed product to access data in said database and retrieve all other physical items in said database which are associated with said unique identifier.

20. A method for managing a production process as recited in claim 15, further comprising:
a. retrieving said unique identifier for said physical items from one particular completed product;
b. using said unique identifier for said physical items from one particular completed product to access data in said database and retrieve all other physical items in said database which are associated with said unique identifier; and
c. using said unique identifier for said physical items from one particular completed product to access data in said database and retrieve all actions in said database which are associated with said unique identifier.
